(19) United States
(12) Patent Application Publication
(10) Pub. No.: US 2014/0220256 A1
(43) Pub. Date: Aug. 7, 2014

(54) PROCESS FOR MANUFACTURING A CONTINUOUS COATED IRON ELECTRODE

(71) Applicant: Encell Technology, Inc., Alachua, FL (US)

(72) Inventor: Randy Gene OGG, Newberry, FL (US)

(73) Assignee: Encell Technology, Inc., Alachua, FL (US)

(21) Appl. No.: 14/169,359

(22) Filed: Jan. 31, 2014

Related U.S. Application Data
(60) Provisional application No. 61/759,777, filed on Feb. 1, 2013.
(60) Provisional application No. 61/898,191, filed on Oct. 31, 2013.

(51) Int. Cl. H01M 4/26; H01M 4/04

(52) U.S. Cl. CPC H01M 4/26; H01M 4/0435; H01M 4/0402; H01M 2004/021
USPC 427/542; 427/126.1; 427/126.6

(57) ABSTRACT

Provided is a continuous process for preparing a high quality and high performance iron electrode. The process comprises preparing a formulation comprising an iron active material and a binder and coating a continuous substrate material on a least one side with the formulation. The coated continuous substrate material is dried, compacted and blanked. A tab is then attached to the electrode.

### CROSS REFERENCE TO RELATED APPLICATIONS

This application claims priority to U.S. Provisional Application Ser. No. 61/759,777, filed Feb. 1, 2013; and U.S. Provisional Application Ser. No. 61/898,191, filed Oct. 31, 2013, which applications are incorporated herein by reference in their entirety.

### BACKGROUND OF THE INVENTION

1. Field of the Invention

The present invention is in the technical field of energy storage devices. More particularly, the present invention is in the technical field of rechargeable batteries employing an iron electrode and a method for preparing same.

2. State of the Art

Iron electrodes have been used in energy storage batteries and other devices for over one hundred years. In particular, iron electrodes are often combined with a nickel-based positive electrode in alkaline electrolyte to form a nickel-iron (Ni—Fe) battery. The Ni—Fe battery is a rechargeable battery having a nickel(III)oxy-hydroxide positive electrode in combination with an iron negative electrode with an alkaline electrolyte such as potassium hydroxide.

The Ni—Fe battery is a very robust battery which is very tolerant of abuse such as overcharge and overdischarge and can have a very long life. It is often used in backup situations where it can be continuously trickle-charged and last more than 20 years.

Traditionally, the iron electrode active material is produced by dissolving pure iron powder in sulfuric acid, followed by drying and roasting to produce iron oxide (Fe₂O₃). The material is washed and partially reduced in hydrogen and partially oxidized to give a mix of Fe and magnetite (Fe₃O₄). Additives such as FeS may be added to the active material mass. The negative electrode structure is typically that of a pocket plate construction wherein the active material is introduced into the current collector. The current collector is made up of steel strips or ribbons that are perforated and nickel plated and the strip formed into a tube or pocket with one end left open for introduction of the active material (D. Linden and T. Reddy, Editors, “Handbook of Batteries, Third Edition”, McGraw-Hill, ©2002).

An alternative process utilizes a porous sintered structure of iron powder, which provides a conductive structure for the active material. This porous plaque is filled with iron hydroxide by either an electrochemical process or by impregnation of the pores with an appropriate iron salt, followed by immersion in alkaline solution. Such electrodes suffer from poor active material loading and corrosion of the iron porous plaque during impregnation, leading to limited life. To achieve sufficient loadings of active material, multiple impregnation cycles are required, adding to cost. Impurities resulting from the impregnation process must be removed by repeated washings to eliminate degradation of cell performance such as high rates of self-discharge.

To address these short-comings, U.S. Pat. No. 4,236,927 describes a process whereby iron powder and a reducible iron compound are mixed together and sintered into a stable body. This mixture is then sintered at high temperature to form a plate of desired shape. While this eliminates the need for a sintered plaque substrate or pockets of Ni-coated steel, it requires high temperature sintering under hydrogen atmosphere. Such processes add considerable complexity and cost in volume manufacturing.

All of these methods for producing iron electrodes are expensive, lead to low active material utilization, and poor specific energy. As a result, Ni—Fe batteries have largely been displaced by other battery technologies due to the high cost of manufacturing and low specific energy. While the technology of preparing iron electrodes is well known and the current preferred process for making these electrodes is a pocket design, pocket design electrodes are not cost effective and are complex in manufacturing. Although the theoretical capacity of an iron electrode is high, in practice only a small percentage of this is achieved due to the poor conductivity of iron oxide. In a pocket electrode design, loss of contact to the external matrix surface results in increased polarization and a drop in cell voltage. To avoid this, large amounts of conductive material such as graphite must be added to the active material, further increasing cost and lowering energy density.

Other forms of electrode production are known in the general rechargeable battery art, particularly electrodes of a pasted construction. This type of electrode typically incorporates a binder with the active material, which can then be coated onto a two or three dimensional current collector, dried, and compacted to form the finished electrode.

U.S. Pat. No. 3,853,624 describes a Ni—Fe battery incorporating iron electrodes employing a metal fiber structure which is loaded with sulfurized magnetic iron oxide by a wet pasting method. The plates are electrochemically formed outside the cell to electrochemically attach the iron active material to the plaque structure. Such a process is unwieldy in high volume manufacturing and adds to product cost.

U.S. Pat. No. 4,021,911 describes an iron electrode wherein the iron active mass is spread onto a grid and rolled and dried. The electrode is then treated with an epoxide resin solution to form a solid reinforcing film-like layer on the electrode surface. However, it can be expected that such a surface film would contribute to an insulating nature to the electrode surface, significantly increasing charge transfer resistance and lowering the cell's ability to sustain high charge and/or discharge rates.

Similarly, PTFE has been proposed as a binder system for paste type electrodes for alkaline batteries. U.S. Pat. No. 3,630,781 describes the use of a PTFE aqueous suspension as a binder system for rechargeable battery electrodes. However, to maintain the PTFE powder in suspension, it is necessary to add surfactants to the suspension, which must be removed from the resultant electrode by extensive washing, adding cost and complexity to the manufacturing process. An alternative approach for a PTFE-bonded electrode is described in U.S. Pat. No. 4,216,045 using fluorocarbon resin powder to form a sheet which can be attached to a conductive body. However, the use of PTFE results in a water-repellent surface, which while beneficial in a recombinant battery such as NiCd or NiMH, is detrimental to the performance of a flooded Fe-Ni battery where good contact between the electrode and electrolyte is beneficial.

Pasted electrodes using various binders have been proposed for alkaline electrodes, most particularly for electrodes employing hydrogen-absorbing alloys for NiMH batteries (for example U.S. Pat. No. 5,780,184). However, the desired properties for these electrodes differ significantly from those desired for a high capacity iron electrode. In the case of the MH electrode, high electrode density (low porosity) is required to maintain good electrical contact between the alloy particles and to facilitate solid-state hydrogen diffusion in the alloy. By contrast, high porosity is desirable for iron electrodes due to the low solubility of the iron oxide species. Hence, binder systems developed for other types of alkaline electrodes have not been optimized for Ni—Fe batteries and hence have not found commercial application.

One object of the present invention is to provide a manufacturing process to produce a high quality and low cost iron electrode that overcomes the limitations of current state-of-the-art pocket and/or sintered iron electrodes. The industry would be well served by a low cost, high quality and high performance iron electrode design, which would enable Ni—Fe batteries to be used in expanded applications.

### SUMMARY OF THE INVENTION

The present invention provides one with a novel process for manufacturing a high quality and low cost continuous coated iron electrode. The present process produces an iron based electrode comprising a single layer of a conductive substrate coated on at least one side with a coating comprising an iron active material and a binder. The electrode is prepared by coating a continuous substrate with a coating mixture comprising the iron active material and binder. The coating process is continuous, which is advantageous economically. The continuous coating process also produces a high quality and high performance iron electrode, and offers flexibility in the formation of the electrode. The iron based electrode produced by this process is useful in alkaline rechargeable batteries, particularly as a negative electrode in a Ni—Fe battery.

Among other factors, it has been discovered that a continuous coating process can be used to prepare a high quality and high performance iron electrode. The continuous process of the present invention produces an iron electrode of the desired structure to enable a high capacity iron electrode for use in rechargeable battery system including, but not limited to, Ni—Fe, Ag—Fe, Fe-air, or MnO₂—Fe.

### BRIEF DESCRIPTION OF THE FIGURES OF THE DRAWING

FIG. 1 is a flow chart for the manufacture of the iron electrode of the present invention using a continuous process.

FIG. 2 is a perspective view of a coated iron electrode of the present invention.

FIG. 3 is a side view and cross-section view of an iron electrode coated on both sides of the substrate in accordance with the present invention.

FIG. 4 is a perspective view of a current pocket iron electrode.

FIG. 5 is a side view and a cross-section view of a current pocket iron electrode.

FIG. 6 is discharge capacities for Ni—Fe cells with iron electrodes having varied binder compositions.

FIG. 7 is discharge capacities for Ni—Fe cells with iron electrodes having varied nickel and iron content.

FIG. 8 is discharge capacities for Ni—Fe cells with iron electrodes having varied sulfur content.

### DETAILED DESCRIPTION OF THE INVENTION

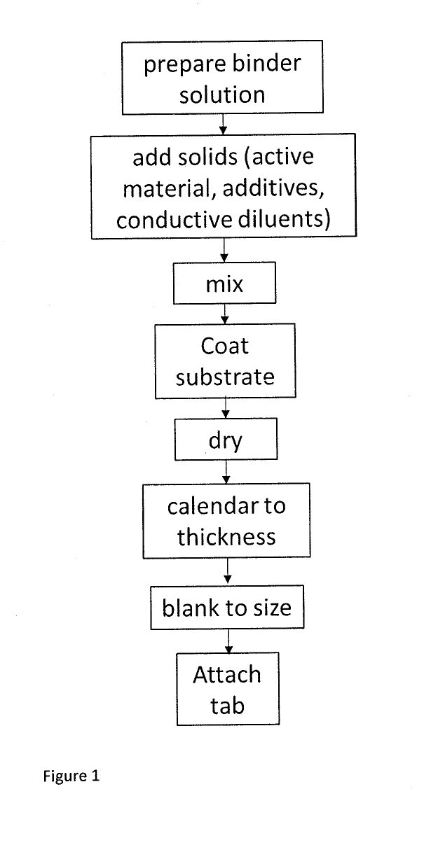

The present invention provides a process for producing an iron electrode comprised of a single conductive substrate coated with iron active material on one or both sides prepared by a continuous coating process. The process comprises mixing iron active material with a binder in a suitable solvent, coating a continuous substrate material on at least one side with the active material mix, drying said coating, and compacting the resultant coating to the desired thickness, blanking, and attaching a tab to the electrode body. An overall process is schematically shown in FIG. 1.

The coating mixture is a combination of binder and active materials in an aqueous or organic solution. The mixture can also contain other additives such as pore formers or conductive additives such as carbon or Ni powder. Pore formers are often used to insure sufficient H₂ movement in the electrode. Examples of pore formers include but are not limited to ammonium carbonate and ammonium bicarbonate. Without sufficient H₂ diffusion and electrode conductivity, the capacity of the battery will be adversely affected. The binder materials have properties that provide adhesion and bonding between the active material particles, both to themselves and to the substrate current collector. The binder is generally resistant to degradation due to aging, temperature, and caustic environment. The binder can comprise polymers, alcohols, rubbers, and other materials, such as an advanced latex formulation that has been proven effective. A polyvinyl alcohol binder is used in one embodiment. Use of a binder to mechanically adhere the active material to the supporting single substrate eliminates the need for expensive sintering or electrochemical post-treatment. Aqueous based solutions have the advantage of lower toxicity and removal of water during the drying process is environmentally friendly and does not require further treatment or capture of the solvent.

There are several advantages to employing PVA as a binder versus conventional binders. PVA is readily water soluble, simplifying the manufacturing process by allowing for direct addition of a PVA solution to the active material mix and eliminating issues associated with shelf life common with PTFE binders. PVA does not impart a hydrophobic nature to the electrode surface, insuring good contact between the active material and the alkaline electrolyte. PVA can be added to the active material paste in the form of a concentrated solution or in powder form. PVA that is hydrolyzed between 98.5 and 100% is preferred in one embodiment. A most preferred embodiment uses PVA that is hydrolyzed between 99.0 and 100%. Furthermore, the PVA has a 4% water solution viscosity between 3-70 cP at 20° C. In a preferred embodiment, the viscosity of a 4% water solution of the PVA is between 20-40 cP at 20° C. In a most preferred embodiment, the viscosity of a 4% water solution of the PVA is between 27-33 cP at 20° C. Concentrations of PVA in the final paste are 1 to 10% by total weight. Preferred concentrations of PVA are in the range of 1 to 5% and a most preferred concentration of PVA in the paste is between 2.5 to 4%. Lower concentrations of PVA do not provide sufficient binding of the active material, while higher concentrations result in an increase in electrode electrical resistance, degrading the performance of the battery under high current loads.

The active material for the mix formulation is selected from iron species that can be reversibly oxidized and reduced. Such materials include iron metal, iron oxide materials and mixtures thereof. The iron oxide material will convert to iron metal when a charge is applied. A suitable iron oxide material includes Fe₃O₄. A preferred form of iron is hydrogen reduced with a purity of about 96% or greater and having a 325 mesh size. In addition, other additives may be added to the mix formulation. These additives include but are not limited to sulfur, antimony, selenium, tellurium, bismuth, tin, and metal sulfides.

Sulfur as an additive has been found to be useful in concentrations ranging from 0.25 to 1.5% and higher concentrations may improve performance even more. Nickel has been used as a conductivity improver and concentrations ranging from 8 to 20% have been found to improve performance and higher concentrations may improve performance even more.

A further advantage of the electrode of the present invention is that additives can be combined into the paste formulation since electrode processing is done at relatively low temperatures where the additives would otherwise be lost at high temperatures. Use of a sintered construction as described in the prior literature precludes addition of additives such as sulfur to the active mass since they would be lost during the sintering process.

An electrode substrate is used as a current conducting and collecting material that houses the active material (iron) of the electrode in a mechanically stable design. Since the resultant iron oxides are not conductive, a conductive substrate is required to maintain electrical contact to the active material. In current pocket electrode designs, the substrate encompasses the active material and holds the material between two layers of conductor, therefore requiring two substrates per electrode. In this process, pockets are formed by interlocking two perforated Ni-coated strips into which the active material is compressed. While such a design offers long life, the energy density is poor.

In the present invention, a single layer of substrate is used. This single layer acts as a carrier with coated material bonded to at least one side. The substrate may be a thin conductive material such as perforated metal foil or sheet, metal mesh or screen, woven metal, or expanded metal. The substrate may also be a three-dimensional material such as a metal foam or metal felt. In one embodiment, a nickel plated perforated foil has been used.

The coating method can be a continuous process that applies the active material mixture to the substrate, such as spraying, dip and wipe, extrusion, low pressure coating die, or surface transfer. A low pressure coating die in which the mix formulation is pumped into a closed die at a continuous rate and applied to the substrate is used in one embodiment. A batch process may also be used, but a continuous process is advantageous regarding cost and processing. The coating method must maintain a high consistency for weight, thickness, and coating uniformity. This insures that finished electrodes will have similar loadings of active material to provide uniform capacity in the finished battery product.

The coating method of the invention is conducive to layering of various materials and providing layers of different properties, such as porosities, densities, and thicknesses. For example, the substrate can be coated with three layers; the first layer being of high density, second layer of medium density, and final layer of a lower density to create a density gradient.

After coating, the electrode is dried to remove any residual liquid, i.e., aqueous or organic solvent. The drying methods will generally provide a continuous method for liquid removal from the coated active material which will enhance the adhesion and binding effects of the dry constituents without iron ignition. This drying method provides a uniform and stable active material coating with the substrate material. Two stages of drying can be used. For example, the first stage can be radiation for bulk drying, for cost and quality control, followed by convection drying to remove the remaining liquid. The radiation used can be any radiation, such as infrared, microwave, or UV, and is very fast. In one embodiment, IR radiation is used. However, the radiation creates a high temperature at the surface of the coated electrode. This high temperature is acceptable as long as there is sufficient water present to act as a heat sink. Therefore, the water is generally removed to about 10-20% by weight water. This can generally be determined using a control chart. Going below 10% water is dangerous, as the electrode becomes too dry and the high surface temperature can ignite the iron active material. Thus, using the convection drying to complete the removal of water or solvent is a preferred embodiment, once the amount of water or solvent remaining is in the 10-20% by weight range. In another embodiment, radiation can be used to compete the drying if the process is conducted in an inert atmosphere.

The compaction methods can be accomplished by rolling mill, vertical pressing, or magnetic compaction of the active material to achieve the desired thickness from 0.005 to 0.50 inches and porosities from 10% to 50%, for high quality and low cost continuous processing. In one embodiment, the porosity of the electrode is from 34-43% with a targeted porosity of 38%. These compaction methods can be used in conjunction with the layering method described above for providing material properties of density, thickness, porosity, and mechanical adhesion.

In addition, continuous in-line surface treatments can be applied continuously throughout any of the steps, including coating, layering, and drying processes. The treatments can apply sulfur, polymer, metal spray, surface laminate, etc. In one embodiment, a polymer post-coat is applied.

Blanks of the electrode are cut to the desired size from the continuous substrate material. The lengthwise size of the blanks will depend on the battery into which the electrode is to be used. The blanks can be cut before the drying step, with each of the separate blanks then dried. The blank can also be cut to the desired size after drying but before compaction. In the embodiment, each blank is then compacted to the desired thickness. In one embodiment, the blanks are cut as noted in FIG. 1, after the drying and compaction steps.

After the drying compaction and blanking steps, a tab is generally attached to the electrode for connection purposes. The tab is constructed of a conductive material and can be attached using conventional methods, such as welding.

The iron electrode can be used with a suitable positive electrode (cathode) to make a battery, e.g., a Ni—Fe battery with a nickel cathode and the iron electrode of this invention. The battery can be made as is conventional, with a standard electrolyte and battery separator. The electrolyte, for example, can be a potassium hydroxide based electrolyte.

The present batteries including the iron electrode can be used, for example, in a cellphone, thereby requiring an electrode with only a single side coated. However, both sides are preferably coated, allowing the battery to be used in many applications as is known in the art.

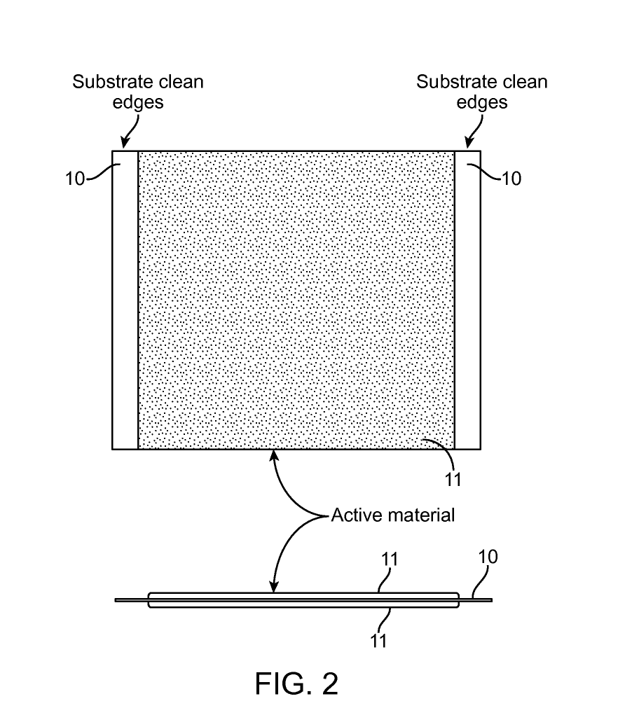

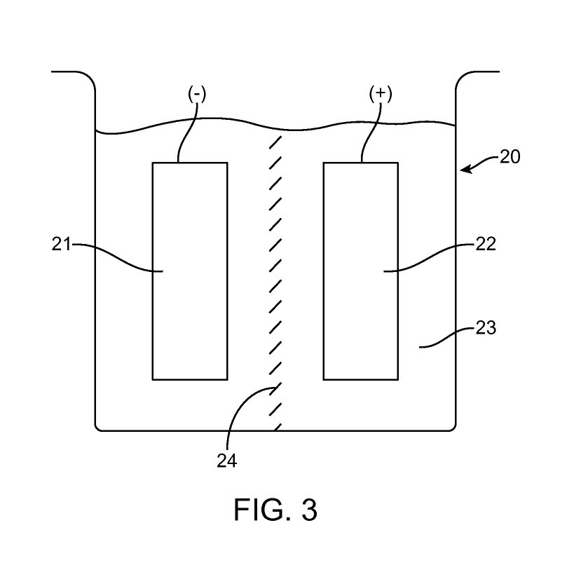

Turning to the figures of the drawing, FIG. 2 is a prospective view of a coated iron electrode. The substrate 1 is coated on each side with a coating 2 comprising the iron active material and binder. This is further shown in FIG. 3. In FIG. 3, the substrate 10 is coated on each side with the coating 11 of the iron active material and binder. The substrate may be coated continuously across the surface of the substrate, or preferably, as shown in FIGS. 2 and 3, cleared lanes of substrate may be uncoated to simplify subsequent operations such as welding of current collector tabs.

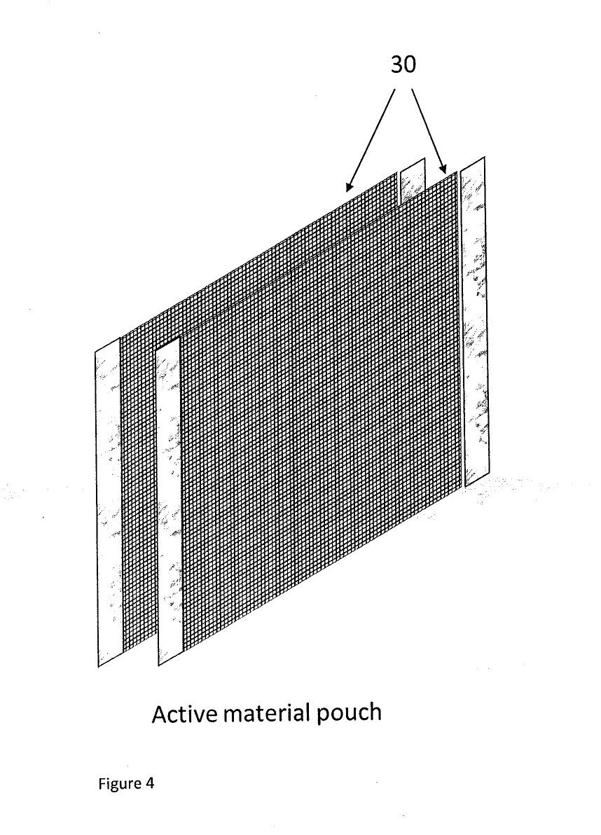

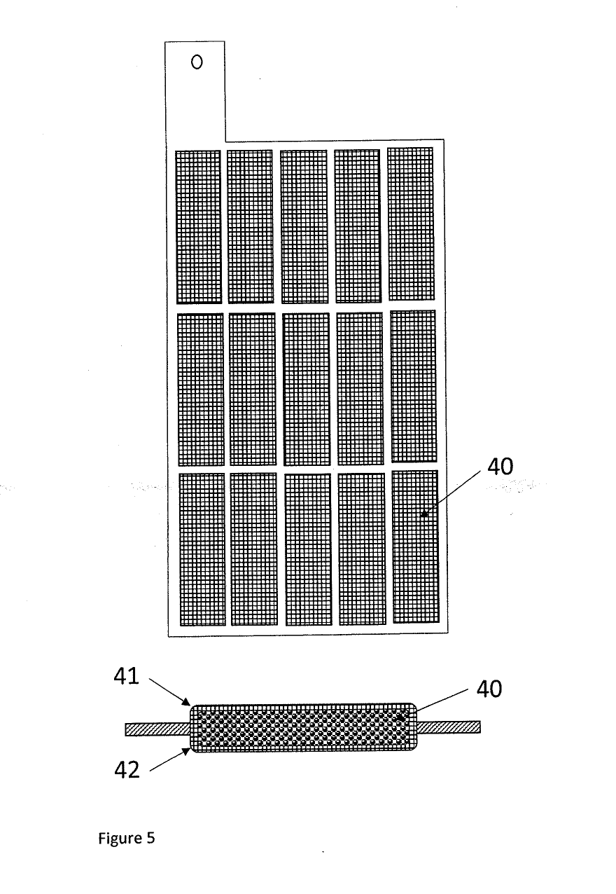

FIGS. 4 and 5 of the drawing show a conventional pocket iron electrode. In FIG. 4, the two substrates 30 are shown to form the pocket which holds the iron active material. In FIG. 5, the iron active material 40 is held between the two substrates 41 and 42.

### ILLUSTRATIVE EXAMPLES

### Paste Preparation

A water based paste comprised of hydrogen reduced iron powder (325 mesh size), 16% nickel powder #255, 0.5% elemental sulfur powder (precipitated, purified) and the appropriate amount of binder was prepared using a digital stirring device and 3-wing stirring blade operating at 1300 RPM for 10-15 minutes. Deionized water was added to the mixture to create a paste with a viscosity between 120,000-130,000 cP.

### Electrode Preparation

### Example 1

The water based paste was applied to a 1.63″ wide nickel-plated continuous perforated strip with 2-mm perforations by feeding the strip fed through the top of an open-bottomed pot attached to a doctor-blade fixture with a gap width set to 0.068″. The paste mixture is poured into the pot and the perforated strip is pulled down at a rate of 2.7 ft/min coating the perforated strip with the paste mixture. Segments ranging 4-5″ are cut from the coated strip and placed into a drying oven at 150° F. for 20 minutes.

After drying the coated strips were cut to a standard length of 3″ and then compressed to thickness to achieve a porosity of approximately 40%. Dried paste mixture was removed from the top 0.25″ of the strip in order to provide a clean space for a stainless steel tab to be spot-welded onto.

### Example 2

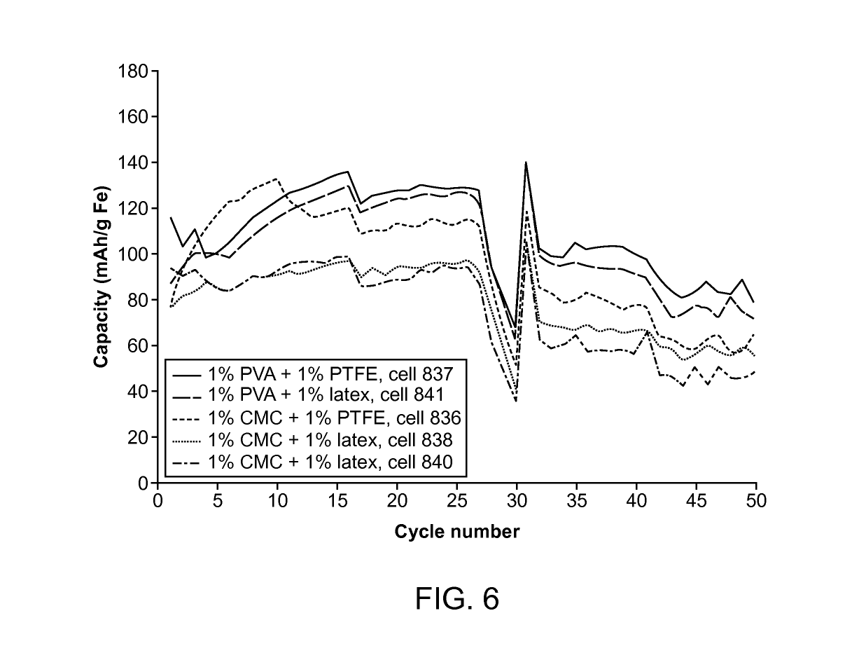

A series of iron electrodes were prepared by impregnating nickel foam with various pastes comprising several different binder compositions described in Table 1. The discharge capacities of the individual cells prepared from these electrodes were measured and plotted against the amount of iron in the anode in FIG. 6. The effect of rate on capacity was evaluated by discharging the cells at multiple rates of C/10, C/5, C/2, and 2C where C represents the current required to discharge the cell in one hour.

TABLE 1

| Cell # | Binder | Binder | g of iron |
|---|---|---|---|
| 1 | 1% CMC | 1% PTFE | 6.4 |
| 2 | 1% PVA | 1% PTFE | 8.5 |
| 3 | 1% CMC | 1% AL-2002 latex | 7.9 |
| 4 | 1% CMC | 1% AL-3001 latex | 7.4 |
| 5 | 1% PVA | 1% AL-1002 latex | 8.3 |

Since the binder can contribute to electrode resistance, it is desirable to employ a binder that minimizes an increase in cell resistance and offers the highest mA h/g capacity. Comparing the 2C capacities of the Ni—Fe batteries, the best results at 2C discharge rate were obtained in cells employing PVA as a binder.

### Example 3

Water based pastes (Table 2) were applied to a 1.63″ wide nickel-plated perforated strip with 2-mm perforations by continuously feeding the strip fed through the top of an open-bottomed pot attached to a doctor-blade fixture with a gap width set to 0.068″. The paste mixture is poured into the pot and the perforated strip is pulled down at a rate of 2.7 ft/min coating the perforated strip with the paste mixture. Segments ranging 4-5″ are cut from the coated strip and placed into a drying oven at 150° C. for 20 minutes.

TABLE 2

| | PVA concentration | | Capacity (mAh/g |
|---|---|---|---|
| Sample | (%) | Iron in electrode (g) | Fe) |
| 1 | 3.5 | 8.3 | 117 |
| 2 | 3.5 | 8.45 | 116 |
| 3 | 3.5 | 11.4 | 112 |
| 4 | 5 | 8.25 | 89 |
| 5 | 7 | 10.1 | 69 |
| 6 | 9 | 8.55 | 8 |

After drying the coated strips were cut to a standard length of 3″ and then compressed to thickness to achieve a porosity of approximately 40%. Dried paste mixture was removed from the top 0.25″ of the strip in order to provide a clean space for a stainless steel tab to be spot-welded onto.

A series of continuously coated iron electrodes were prepared by coating perforated NPS with an aqueous mixture of iron powder, nickel powder as a conductivity aid, elemental sulfur and employing PVA as a binder. Multiple levels of PVA were employed in the mixes to evaluate the effect of binder concentration on mechanical stability of the electrode and rate capability of the electrode. At concentrations below 3 weight percent PVA, the physical integrity of the electrodes was unacceptable. Concentrations of binder above about 5 weight percent showed a sharp drop in discharge capacity, most likely due to increased electrode resistance and possibly masking of the active material from the electrolyte interface. Data for cells with varying levels of PVA is summarized in Table 2.

### Example 4

A 10 wt % solution of PVA (Elvanol 7130) preheated to between 120-125° F. was added to a jacketed container with iron powder (325 mesh), nickel powder #255, and sulfur preheated to 120° F. This mixture was stirred for 30 minutes at 120° F. The solid component mixture of this paste was 80% iron, 16% nickel, 0.4% sulfur, and 3.5% PVA. Viscosity measurements of the paste had a range of 25000 to 39000 cP immediately after removal from the container and after a further 90 seconds, the viscosity ranged from 22000 to 31000 cP.

The paste mixture was then transferred to a jacketed holding tank preheated to 110° F. where it was stirred. The paste was pumped to a paste hopper where a perforated nickel plated steel strip was coated. The coated strip was then passed through a doctor blade to achieve a coating thickness between 0.040-0.050″ and introduced to a vertical drying oven. The first stage of drying consisted of IR heating at 240° F. for 1.67 minutes followed by heating in a conventional oven at 240° F. for 3.35 minutes. The second drying stage with a residence time of 1.7 minutes consisted of forced hot air with a set drying temperature of 260° F. The paste temperature exiting the ovens did not exceed 210° F. After cooling, the finished coating was calendared to a thickness of 0.025″. Pieces of the coating were cut to size and weighed to obtain coating porosity. The porosity ranged from 34-43% with a targeted porosity of 38%.

Electrodes from Example 4 were used to construct a Ni—Fe battery. Table 3 shows the performance of the iron electrode in comparison to other commercial Ni—Fe batteries employing pocket plate electrodes.

TABLE 3

| | | | | | | Electrode |
|---|---|---|---|---|---|---|
| | Chinese | Chinese | | | | of present |
| Cell | Seiden | Taihang | Ukrainian | Russian | Zappworks | invention |
| Ah/g | 0.095 Ah/g | 0.130 Ah/g | 0.117 Ah/g | 0.116 Ah/g | — | 0.126 Ah/g |
| (powder) | | | | | | |
| Ah/g | 0.059 Ah/g | 0.076 Ah/g | 0.075 Ah/g | 0.084 Ah/g | 0.034 Ah/g | 0.105 Ah/g |
| (total electrode) | | | | | | |
| Ah/cm³ | 0.199 Ah/cm³ | 0.203 Ah/cm³ | 0.216 Ah/cm³ | 0.238 Ah/cm³ | 0.099 Ah/cm³ | 0.430 Ah/cm³ |
| (total electrode) | | | | | | |
| Type of iron | Pocket | Pocket | Pocket | Pocket | Pocket | Continuous |
| electrode | plate | plate | plate | plate | plate | coated (Pasted) |

### Example 5

### Paste Preparation

A water based paste comprised of hydrogen reduced iron powder (325 mesh size), nickel powder #255, elemental sulfur powder (precipitated, purified) and the appropriate amount of binder was prepared using a digital stirring device and 3-wing stirring blade operating at 1300 RPM for 10-15 minutes. Deionized water was added to the mixture to create a paste with a viscosity between 120,000-130,000 cP. The nickel and iron content was varied according to Table 3, the sulfur content was 0.5%, and the binder content was 3.5%.

Water based pastes with varying nickel and iron content (Table 4) were applied to a 1.63″ wide nickel-plated perforated strip with 2-mm perforations by feeding the strip fed through the top of an open-bottomed pot attached to a doctor-blade fixture with a gap width set to 0.068″. The paste mixture is poured into the pot and the perforated strip is pulled down at a rate of 2.7 ft/min coating the perforated strip with the paste mixture. Segments ranging 4-5″ are cut from the coated strip and placed into a drying oven at 150° C. for 20 minutes.

TABLE 4

| Sample | Nickel (%) | Iron % |
|---|---|---|
| 1 | 8 | 88 |
| 2 | 12 | 84 |
| 3 | 16 | 80 |
| 4 | 20 | 76 |

After drying the coated strips were cut to a standard length of 3″ and then compressed to thickness to achieve a porosity of approximately 40%. Dried paste mixture was removed from the top 0.25″ of the strip in order to provide a clean space for a stainless steel tab to be spot-welded onto.

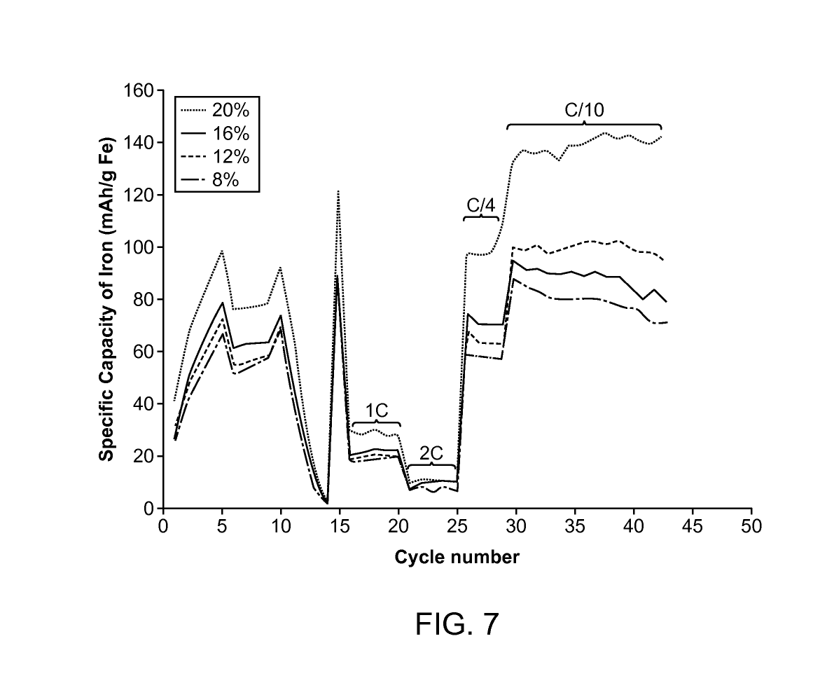

Ni—Fe cells were constructed using electrodes fabricated from the pastes with varying nickel and iron content. The data is shown in FIG. 7. The cell performance does not appear to be very dependent upon nickel concentration in the concentration range between 8-16% but improved capacity at high (1 C) and low rates (C/10) is observed for electrodes with 20% nickel.

### Example 6

### Paste Preparation

A water based paste comprised of hydrogen reduced iron powder (325 mesh size), nickel powder #255, elemental sulfur powder (precipitated, purified) and the appropriate amount of binder was prepared using a digital stirring device and 3-wing stirring blade operating at 1300 RPM for 10-15 minutes. Deionized water was added to the mixture to create a paste with a viscosity between 120,000-130,000 cP. The nickel content was 16%, polyvinyl alcohol 3.5%, and the sulfur content was varied between 0 and 1.5% with the remainder of the electrode composition being iron powder.

Water based pastes with varying sulfur content were applied to a 1.63″ wide nickel-plated perforated strip with 2-mm perforations by feeding the strip fed through the top of an open-bottomed pot attached to a doctor-blade fixture with a gap width set to 0.068″. The paste mixture is poured into the pot and the perforated strip is pulled down at a rate of 2.7 ft/min coating the perforated strip with the paste mixture. Segments ranging 4-5″ are cut from the coated strip and placed into a drying oven at 150° C. for 20 minutes.

After drying the coated strips were cut to a standard length of 3″ and then compressed to thickness to achieve a porosity of approximately 40%. Dried paste mixture was removed from the top 0.25″ of the strip in order to provide a clean space for a stainless steel tab to be spot-welded onto.

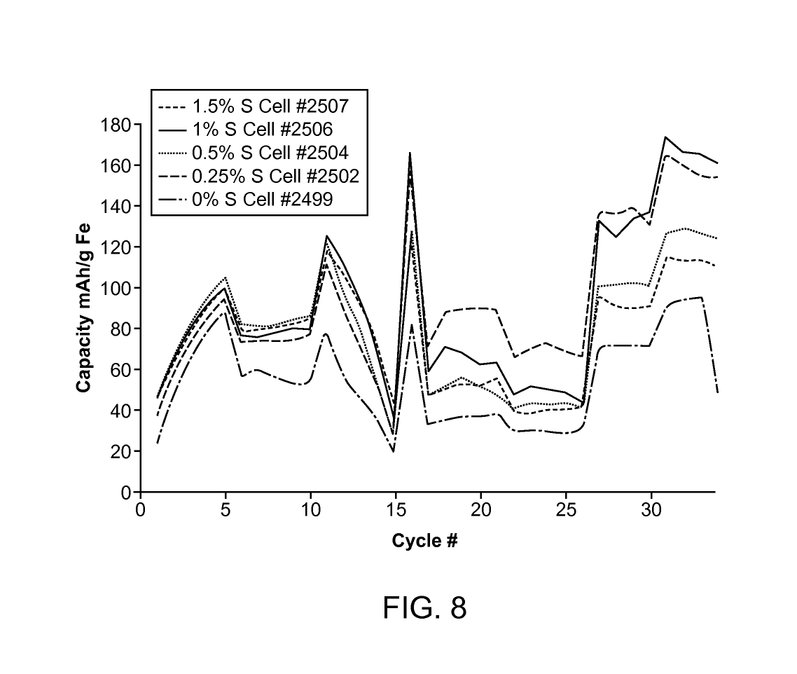

Ni—Fe cells were constructed using electrodes fabricated from the pastes with varying sulfur content. The data is shown in FIG. 8. Increasing the sulfur content of the electrode increases the capacity at the C/10 discharge rate until the sulfur content reaches about 1.5% where there is no further increase in capacity. Increasing the sulfur content increased the capacity of the iron electrode even at sulfur contents up to 1.5% at the 1 C and 2C discharge rates.

In Ni—Fe cells constructed with iron electrodes prepared using the process of the foregoing examples, an electrolyte comprising sodium hydroxide (NaOH), lithium hydroxide (LiOH), and sodium sulfide (Na₂S) was used. A sintered nickel electrode impregnated with nickel hydroxide was used as the positive electrode and a 0.010 inch thick polyolefin non-woven mesh was used as the separator in these examples of Ni—Fe cells with the iron electrode of the present invention. The electrolyte used in the conventional Ni—Fe battery was potassium hydroxide (KOH) and the anode and cathode were kept electrically isolated using a spacer. The results show a vast improvement in performance characteristics for the inventive Ni—Fe battery.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A process for preparing an iron electrode, comprising
preparing a mix comprising an iron active material and a binder;
coating a continuous substrate material on at least one side with the mix;
drying, compacting and cutting the electrode to size; and
attaching a tab to the electrode.

2. The process of claim 1, wherein the binder comprises polyvinyl alcohol.

3. The process of claim 2, wherein the amount of polyvinyl alcohol in the electrode is in the range of from 2 to 5 wt %.

4. The process of claim 2, wherein the amount of polyvinyl alcohol in the electrode is in the range of from 2.5 to 4 wt %.

5. The process of claim 1, wherein the iron active material comprises Fe metal.

6. The process of claim 1, wherein the iron active material comprises Fe₃O₄.

7. The process of claim 1, wherein the mix further comprises water as solvent for the polyvinyl alcohol.

8. The process of claim 1, wherein the mix further comprises an additive.

9. The process of claim 8, wherein the additive comprises nickel powder.

10. The process of claim 8, wherein the additive comprises sulfur.

11. The process of claim 10, wherein the sulfur comprises elemental sulfur.

12. The process of claim 9, wherein the additive further comprises elemental sulfur.

13. The process of claim 1, wherein the coating of the continuous substrate comprises layering of materials having different properties.

14. The process of claim 13, wherein the layers have different porosities and/or densities.

15. The process of claim 13, wherein the layers have different concentrations of additives.

16. The process of claim 1, wherein the drying is conducted with a combination of IR, microwave or UV drying in a first step, and convection drying in a second step.

17. The process of claim 16, wherein the convection drying occurs once the amount of water or solvent remaining is in the 10-20% weight range.

18. The process of claim 1, wherein the drying is conducted in an inert atmosphere.

19. The process of claim 1, wherein the compaction is accomplished by rolling mill, vertical pressing or magnetic compaction.

20. The process of claim 19, wherein the compaction is sufficient to achieve a thickness of 0.005 to 0.50 inches.

21. The process of claim 19, wherein the porosity of the electrode after compaction is in the range of from 10 to 50%.

22. The process of claim 1, wherein the porosity of the electrode after compaction is in the range of 34-43%.

23. The process of claim 1, wherein a polymer coating is applied to the electrode after the drying and compaction.
